(19) United States
(12) Patent Application Publication
(10) Pub. No.: US 2025/0260192 A1
(43) Pub. Date: Aug. 14, 2025

(54) CONNECTOR

(71) Applicant: YAZAKI CORPORATION, Tokyo (JP)

(72) Inventors: Yuya Yamada, Makinohara-shi (JP); Minami Soga, Makinohara-shi (JP)

(21) Appl. No.: 19/035,863

(22) Filed: Jan. 24, 2025

(30) Foreign Application Priority Data
Feb. 13, 2024 (JP) 2024-019090

(51) Int. Cl. H01R 13/52; H01R 13/506

(52) U.S. Cl. CPC H01R 13/5202; H01R 13/506

(57) ABSTRACT

A connector includes: a housing; and a water stop member mounted in the housing and configured to stop water between the mating connector and the housing, in which the housing has a tubular assembly space in which a facing surface of the housing that faces the mating connector is recessed in a fitting direction, and includes a locking protrusion protruding from an outer peripheral wall portion of the assembly space, the water stop member includes a retaining portion that is arranged in the assembly space and protrudes toward an outer peripheral side from an annular main body portion, and the main body portion of the water stop member has a cavity portion formed on a distal end side of a proximal end portion of the retaining portion.

### CROSS-REFERENCE TO RELATED APPLICATION(S)

The present application claims priority to and incorporates by reference the entire contents of Japanese Patent Application No. 2024-019090 filed in Japan on Feb. 13, 2024.

### BACKGROUND OF THE INVENTION

### 1. Field of the Invention

The present invention relates to a connector.

### 2. Description of the Related Art

Hitherto, as a connector, for example, a connector in which an annular assembly space is formed around a terminal accommodation portion as described in Japanese Patent Application Laid-open No. 2006-147474 has been known. In the connector, a water stop member is mounted in the assembly space and stops water between the connector and a fitted mating connector.

There is room for improvement in the connector in that it is not easy to mount the water stop member. For example, the water stop member needs to be locked so as not to be easily removed from the assembly space in a state of being mounted in the assembly space. For this reason, a mounting force for the water stop member becomes large in order to mount the water stop member in a state of being locked to the assembly space, and thus, it may be difficult to mount the water stop member in the assembly space.

### SUMMARY OF THE INVENTION

Therefore, an object of the present invention is to provide a connector that enables smooth assembly of a water stop member.

In order to achieve the above mentioned object, a connector according to one aspect of the present invention includes a housing into which a mating connector is fitted; and a water stop member mounted in the housing and configured to stop water between the mating connector and the housing, wherein the housing has a tubular assembly space in which a facing surface of the housing that faces the mating connector is recessed in a fitting direction, and includes a locking protrusion protruding from an outer peripheral wall portion of the assembly space, the water stop member includes a retaining portion that is arranged in the assembly space and protrudes toward an outer peripheral side from an annular main body portion, and the main body portion of the water stop member has a cavity portion formed on a distal end side of a proximal end portion of the retaining portion.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is an exploded perspective view of a connector according to an embodiment;

FIG. 2 is a view illustrating a housing of the connector according to the embodiment;

FIG. 3 is a cross-sectional view of the housing taken along line III-III of FIG. 2;

FIG. 4 is a perspective view of a water stop member of the connector according to the embodiment;

FIG. 5 is a perspective view of the connector according to the embodiment;

FIG. 6 is a cross-sectional view of the connector taken along line VI-VI of FIG. 5;

FIG. 7 is an explanatory view of assembly of the connector according to the embodiment;

FIG. 8 is an explanatory view of the assembly of the connector according to the embodiment;

FIG. 9 is an explanatory view of assembly of the connector according to the embodiment; and

FIG. 10 is an explanatory view of the assembly of the connector according to the embodiment.

### DETAILED DESCRIPTION OF THE PREFERRED EMBODIMENTS

Hereinafter, an embodiment according to the present invention will be described in detail with reference to the drawings. Note that the present invention is not limited by the embodiment. In addition, constituent elements in the following embodiment include those that can be easily replaced by those skilled in the art or those that are substantially the same.

### EMBODIMENT

The present embodiment relates to a connector. In the following description, a first direction is referred to as a “connection direction X”, a second direction is referred to as a “width direction Y”, and a third direction is referred to as a “height direction Z”, the first direction, the second direction, and the third direction intersecting one another. Here, the connection direction X, the width direction Y, and the height direction Z are orthogonal to each other. The connection direction X corresponds to a connection direction and a fitting direction of the connector and a mating connector. The width direction Y and the height direction Z correspond to directions intersecting with the connection direction X. In addition, each direction used in the following description represents a direction in a state where the parts are assembled unless otherwise specified. The term “orthogonal” as used herein includes being substantially orthogonal.

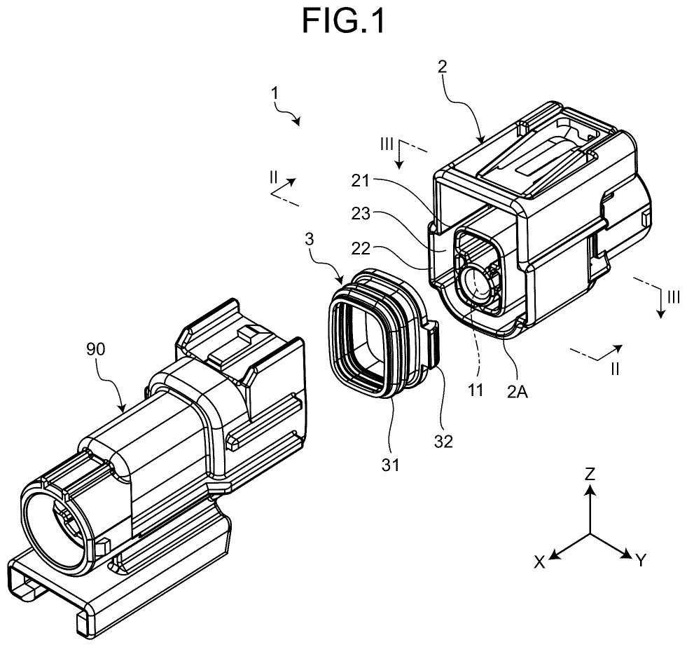

As illustrated in FIG. 1, a connector 1 is a connector used for connection with a mating connector 90, and includes a housing 2 and a water stop member 3. The connector 1 is mounted on a vehicle, for example, and is used as a component of a wire harness WH.

The housing 2 is a part that accommodates and holds a terminal 11, and includes a terminal accommodation portion 21 extending in the connection direction X. The terminal accommodation portion 21 is a cylindrical body extending in the connection direction X, and an end portion of a distal end side of the terminal accommodation portion 21 that faces the mating connector 90 is opened. An outer tubular portion 22 is provided around the terminal accommodation portion 21. The outer tubular portion 22 is formed so as to cover an outer periphery of the terminal accommodation portion 21, and is provided so as to form multiple layers with the terminal accommodation portion 21 internally and externally.

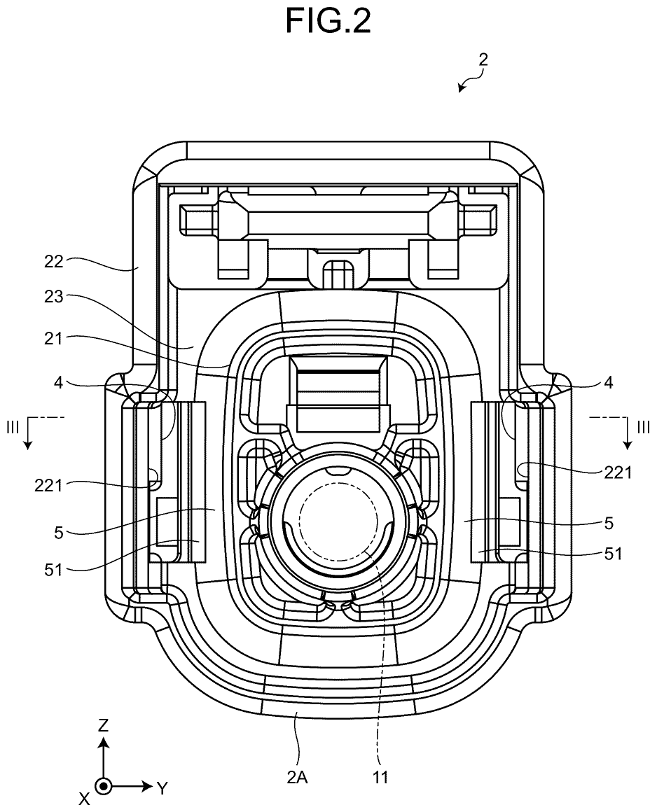

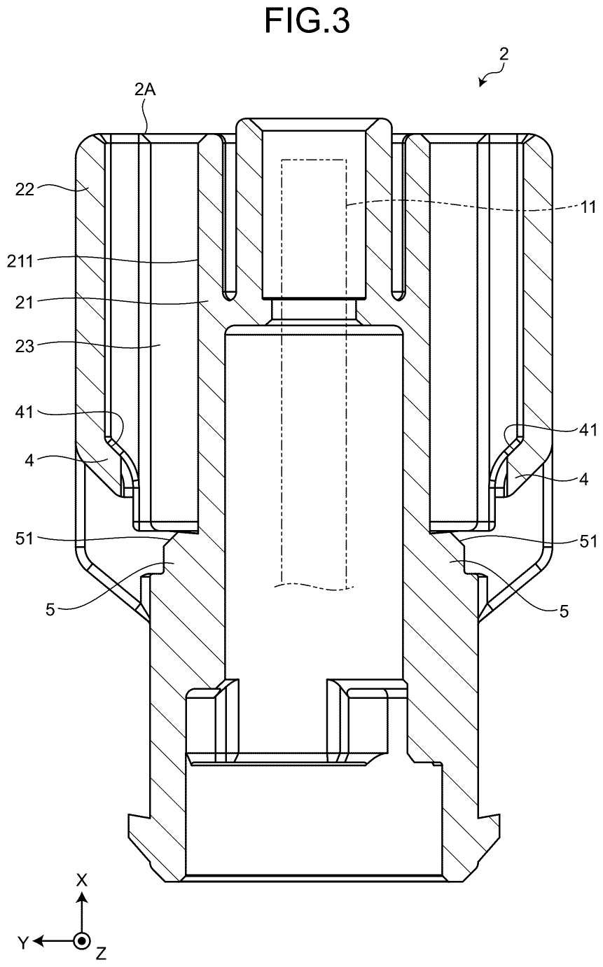

As illustrated in FIGS. 2 and 3, an assembly space 23 is formed between the terminal accommodation portion 21 and the outer tubular portion 22. FIG. 2 is a front view of the housing 2 when the housing 2 is viewed from a side of a facing surface 2A that faces the mating connector 90. The assembly space 23 is a space to which the water stop member 3 is assembled, and is a space into which the mating connector 90 is inserted and fitted. The assembly space 23 is a tubular space in which the facing surface 2A facing the mating connector 90 is recessed in the fitting direction. That is, the assembly space 23 is formed in a tubular shape between the terminal accommodation portion 21 and the outer tubular portion 22. The mating connector 90 includes a tubular fitting portion that can be inserted into the assembly space 23.

The housing 2 includes a locking protrusion 4. The locking protrusion 4 is a protrusion protruding from an outer peripheral wall portion of the assembly space 23. The locking protrusion 4 is engaged with the water stop member 3 to suppress the water stop member 3 arranged in the assembly space 23 from moving from an arrangement position. For example, two locking protrusions 4 are formed with the terminal accommodation portion 21 interposed therebetween. The locking protrusion 4 protrudes from an inner wall surface 221 of the outer tubular portion 22 toward the terminal accommodation portion 21. In addition, the locking protrusion 4 is formed to be inclined such that the assembly space 23 is tapered toward a back side of the assembly space 23 (a lower side in FIG. 3). That is, an inner wall surface 41 of the locking protrusion 4 is a tapered surface that tapers the assembly space 23 toward the back side. Therefore, in a case where the water stop member 3 is assembled to the assembly space 23, the locking protrusion 4 smoothly moves and guides the water stop member 3 to the back side of the assembly space 23.

The housing 2 has a protruding portion 5 formed in the assembly space 23. The protruding portion 5 is a portion protruding from an inner peripheral wall portion of the assembly space 23 toward an outer peripheral side, and comes into contact with a retaining portion 32 of the water stop member 3 assembled to the assembly space 23. The protruding portion 5 protrudes from an outer wall surface 211 of the terminal accommodation portion 21 toward the outer tubular portion 22. The protruding portion 5 is formed on a back side than the locking protrusion 4 in the assembly space 23. The protruding portion 5 has a tapered surface 51 obtained by chamfering a corner portion on an inlet side. Therefore, in a case where the water stop member 3 is assembled to the assembly space 23, the protruding portion 5 smoothly moves and guides the water stop member 3 to the back side of the assembly space 23.

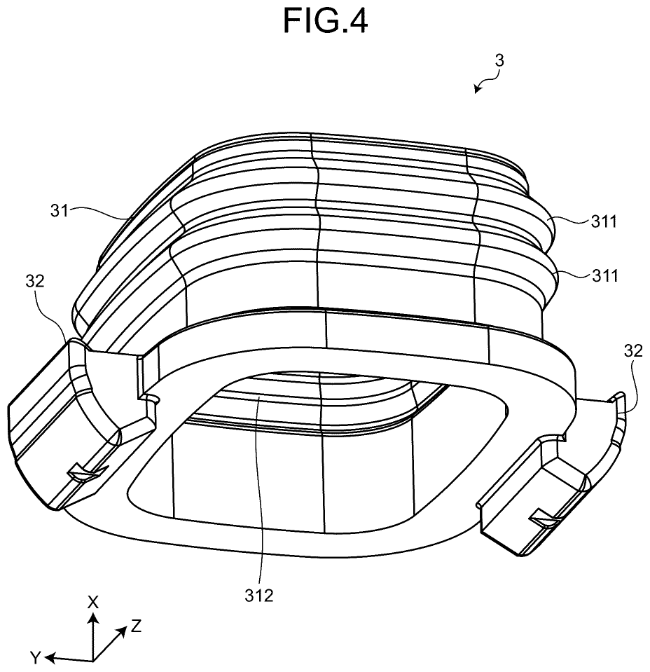

As illustrated in FIG. 4, the water stop member 3 is a packing member that is mounted on the housing 2 and stops water between the mating connector 90 and the housing 2. The water stop member 3 is formed of, for example, a deformable elastic member. The water stop member 3 is mounted in the assembly space 23 of the housing 2. The water stop member 3 includes a main body portion 31 and the retaining portion 32. The main body portion 31 is a portion that is formed in an annular shape and stops water. An outer peripheral lip portion 311 is formed on an outer peripheral surface of the main body portion 31, and an inner peripheral lip portion 312 is formed on an inner peripheral surface of the main body portion 31. For example, a plurality of outer peripheral lip portions 311 and a plurality of inner peripheral lip portions 312 are provided in the connection direction X.

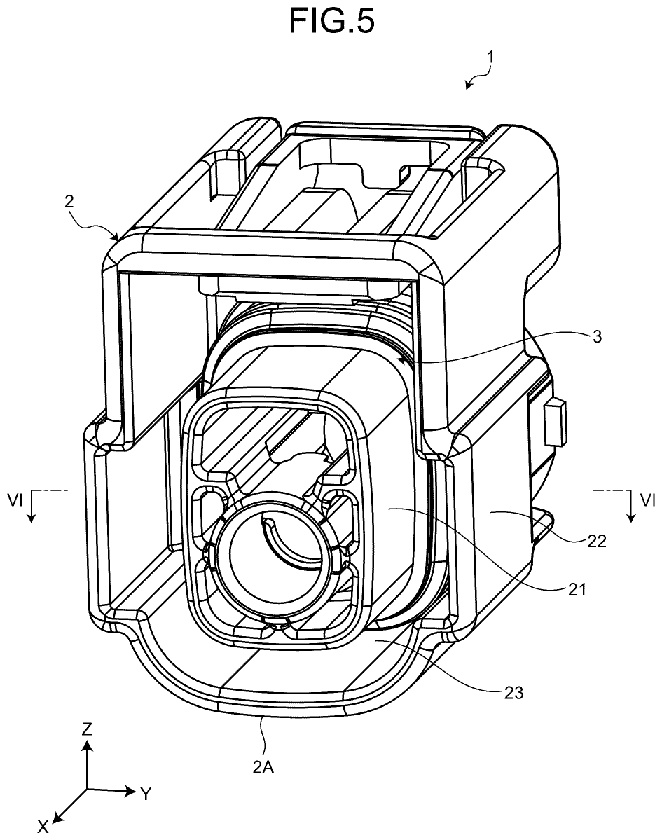

As illustrated in FIG. 5, the water stop member 3 is inserted into and assembled to the assembly space 23 of the housing 2. That is, the water stop member 3 is inserted into the assembly space 23 from the side of the facing surface 2A that faces the mating connector 90, is provided so as to cover the outer periphery of the terminal accommodation portion 21, and is arranged at a back side position in the assembly space 23.

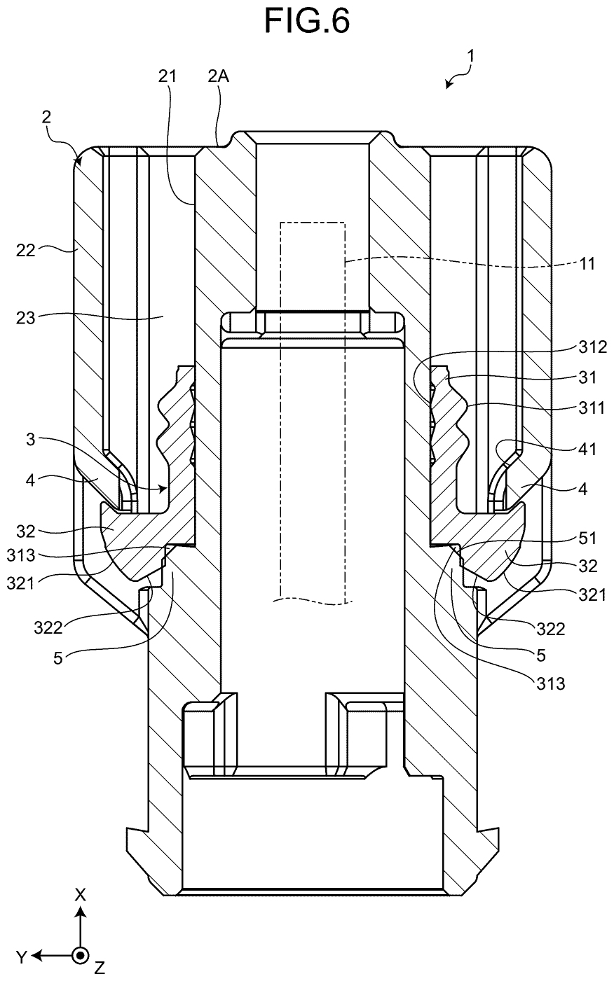

As illustrated in FIG. 6, the inner peripheral lip portion 312 of the water stop member 3 comes into contact with an outer peripheral surface of the terminal accommodation portion 21. The outer peripheral lip portion 311 comes into contact with the mating connector 90 inserted into the assembly space 23. Accordingly, the water stop member 3 stops water between the housing 2 and the mating connector 90.

The water stop member 3 includes the retaining portion 32 protruding from the main body portion 31 toward an outer peripheral side. The retaining portion 32 is a portion that suppresses the water stop member 3 arranged in the assembly space 23 from moving from the arrangement position, and is engaged with the locking protrusion 4. That is, when the water stop member 3 is inserted into the assembly space 23, the retaining portion 32 passes through the inside of the locking protrusion 4, moves to a position on the back side of the locking protrusion 4, and is engaged with the locking protrusion 4. For example, two retaining portions 32 are formed with the main body portion 31 interposed therebetween, are provided with the terminal accommodation portion 21 interposed therebetween when the water stop member 3 is mounted, and are arranged at positions corresponding to the locking protrusions 4.

The main body portion 31 of the water stop member 3 has a cavity portion 313 on a distal end side of a proximal end portion of the retaining portion 32. The cavity portion 313 is a space portion formed at the proximal end portion of the retaining portion 32 protruding toward the outer tubular portion 22, and facilitates deformation of the retaining portion 32 when the water stop member 3 is assembled.

The retaining portion 32 has a curved surface 321 formed at a corner portion that comes into contact with the locking protrusion 4 in a state where the water stop member 3 is mounted in the assembly space 23. For example, the curved surface 321 is formed at a distal end portion of the retaining portion 32, and comes into contact with the tapered inner wall surface 41 of the locking protrusion 4 when the water stop member 3 is mounted.

In the retaining portion 32, a tapered portion 322 is formed at a corner portion that comes into contact with the tapered surface 51 in a state where the water stop member 3 is mounted in the assembly space 23. The tapered portion 322 is formed, for example, at the distal end portion of the retaining portion 32, and is provided so as to be parallel or substantially parallel to the tapered surface 51 of the protruding portion 5 when the water stop member 3 is mounted.

Next, assembly of the connector 1 according to the present embodiment will be described.

As illustrated in FIG. 1, the assembly of the connector 1 is performed by assembling the water stop member 3 to the housing 2. In the assembly of the connector 1, parts or members other than the water stop member 3 may also be assembled to the housing 2.

First, the water stop member 3 is arranged so as to face the housing 2, and the water stop member 3 is inserted into the assembly space 23. The water stop member 3 is inserted with the retaining portion 32 at the front such that the retaining portion 32 is arranged on the back side of the assembly space 23.

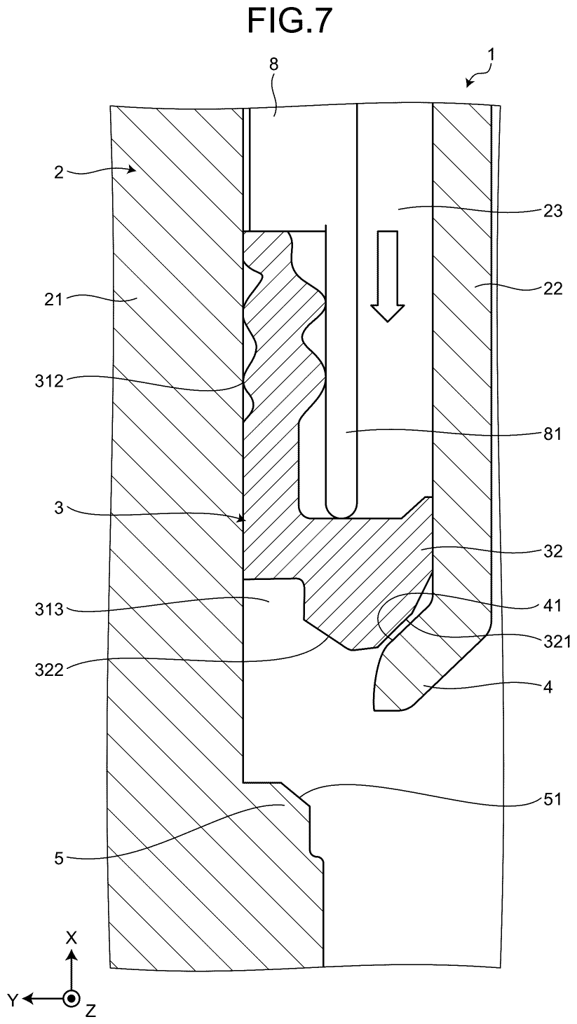

As illustrated in FIG. 7, mounting of the water stop member 3 in the assembly space 23 is performed using, for example, a jig 8. The jig 8 is a tubular body that can be inserted into the assembly space 23, and has a thin tip portion 81 at a tip of the jig 8. The tip portion 81 has an inner diameter capable of covering an outer periphery of the main body portion 31 of the water stop member 3 and is formed to have the same length as the main body portion 31 in the connection direction X, and an end portion of a distal end side of the tip portion 81 comes into contact with the retaining portion 32.

The water stop member 3 is pushed by the jig 8 and inserted to reach the back side of the assembly space 23. At this time, the water stop member 3 moves in the connection direction X in a state where the inner peripheral lip portion 312 is in contact with the outer peripheral surface of the terminal accommodation portion 21 and the retaining portion 32 is in contact with an inner peripheral surface of the outer tubular portion 22. Once the retaining portion 32 moves to the position corresponding to the locking protrusion 4, the retaining portion 32 comes into contact with the inner wall surface 41 of the locking protrusion 4. When the retaining portion 32 comes into contact with the locking protrusion 4, an insertion resistance against the water stop member 3 increases.

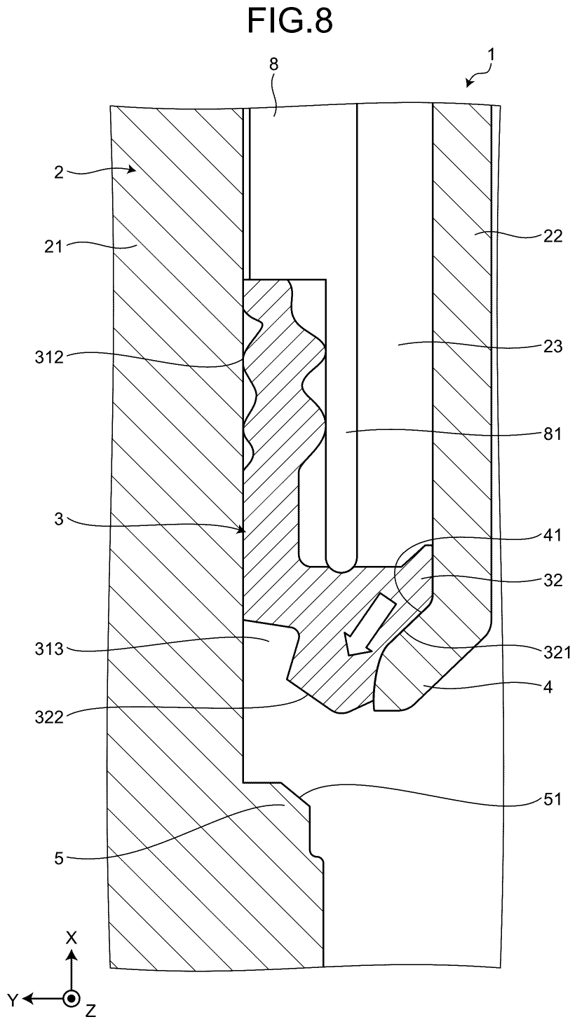

As illustrated in FIG. 8, when the water stop member 3 is further pushed by the jig 8, the retaining portion 32 is deformed inward along the inner wall surface 41 of the locking protrusion 4 and moves to the back side of the assembly space 23. At this time, the inner wall surface 41 is inclined so as to extend inward toward the back side, and the retaining portion 32 has the curved surface 321 at an end portion protruding toward the outer peripheral side. Therefore, the curved surface 321 comes into contact with the inner wall surface 41, the curved surface 321 slides with respect to the inner wall surface 41, and the retaining portion 32 moves along the inner wall surface 41. Therefore, in the connector 1 according to the present embodiment, the water stop member 3 can be easily inserted into the back side of the assembly space 23 at the position where the locking protrusion 4 is formed.

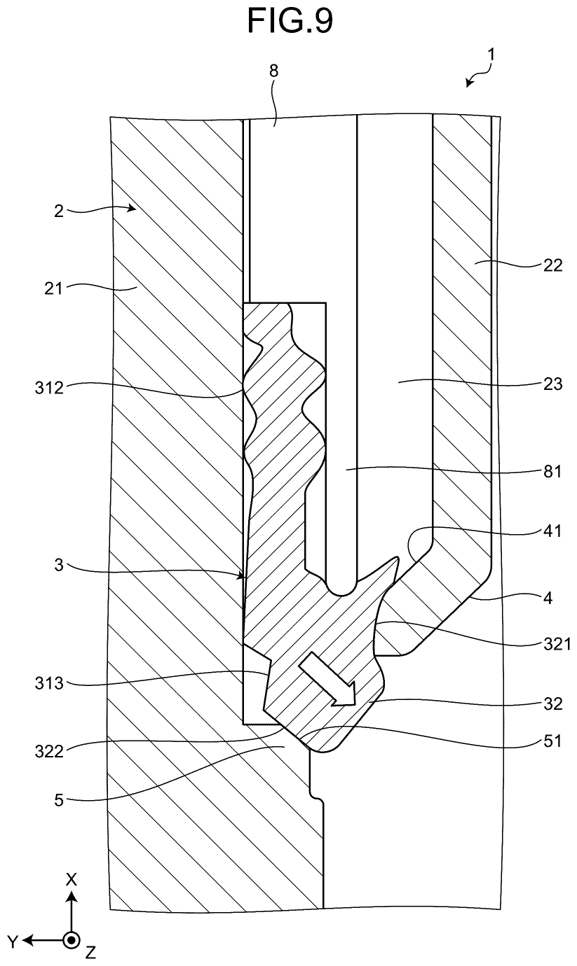

As illustrated in FIG. 9, when the water stop member 3 is further pushed by the jig 8, the retaining portion 32 is deformed so as to be tilted toward the back side. That is, as the retaining portion 32 is pushed by the tip portion 81 of the jig 8, the retaining portion 32 is deformed so as to fall to the back side of the assembly space 23. That is, since the cavity portion 313 is formed in the water stop member 3, the retaining portion 32 has a structure that is easily deformed so as to fall to an end portion side of the water stop member 3, that is, the back side of the assembly space 23. Therefore, the retaining portion 32 is deformed so as to fall to the back side of the assembly space 23 and moves to the back side than locking protrusion 4 through the inside of the locking protrusion 4.

The retaining portion 32 that has moved to the back side than the locking protrusion 4 comes into contact with the protruding portion 5. When the retaining portion 32 comes into contact with the protruding portion 5, the insertion resistance against the water stop member 3 increases. However, the tapered surface 51 is formed in the protruding portion 5, and the tapered portion 322 is formed in the retaining portion 32. Therefore, even when the retaining portion 32 comes into contact with the protruding portion 5, the retaining portion 32 is guided toward the back side by the tapered surface 51 of the protruding portion 5. In addition, the tapered portion 322 comes into contact with and slides with respect to the tapered surface 51, so that the insertion resistance against the water stop member 3 decreases. Therefore, in the connector 1 according to the present embodiment, the water stop member 3 can be easily inserted into the back side of the assembly space 23 at a position where the protruding portion 5 is formed.

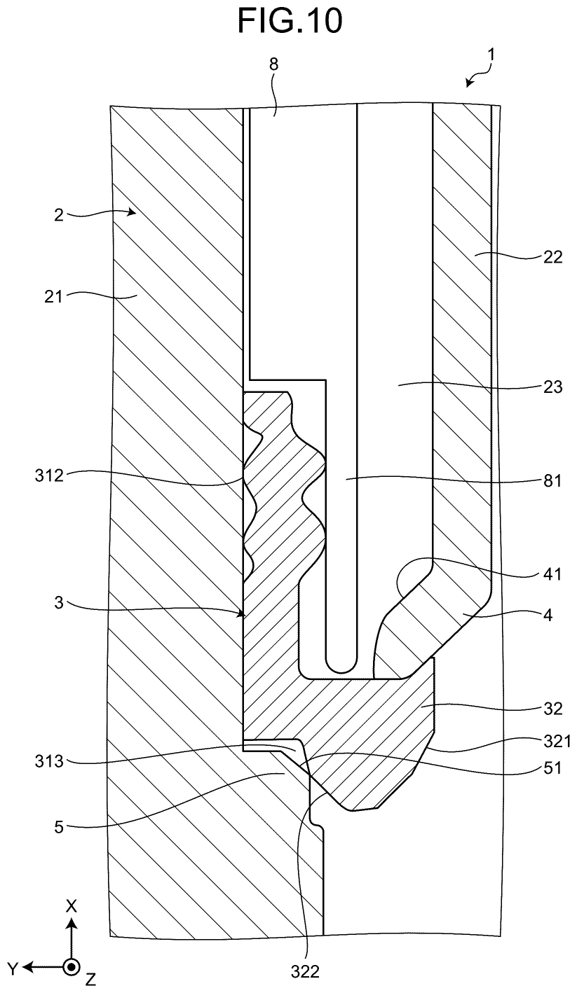

As illustrated in FIG. 10, when the retaining portion 32 moves to an outer peripheral side of the protruding portion 5, the retaining portion 32 is positioned on the back side of the locking protrusion 4, and the water stop member 3 is arranged at a desired position. The retaining portion 32 is engaged with the locking protrusion 4 to suppress easy movement of the water stop member 3 from the arrangement position. In this way, the assembly of the connector 1 is completed.

As described above, in the connector 1 according to the present embodiment, the cavity portion 313 is formed in the main body portion 31 of the water stop member 3, so that deformation of the water stop member 3 is facilitated, and the water stop member 3 can be smoothly mounted in the assembly space 23 of the housing 2. Therefore, the connector according to the present embodiment can be easily assembled.

In the connector 1 according to the present embodiment, the curved surface 321 is formed at the corner portion where the retaining portion 32 of the water stop member 3 comes into contact with the locking protrusion 4, so that the water stop member 3 can be smoothly mounted in the assembly space 23 of the housing 2.

Further, in the connector 1 according to the present embodiment, by forming the tapered surface 51 at the corner portion of the protruding portion 5 of the housing 2, the retaining portion 32 can be easily inserted into the back side of the assembly space 23, and the water stop member 3 can be smoothly mounted in the assembly space of the housing 2.

Furthermore, in the connector 1 according to the present embodiment, by forming the tapered portion 322 in the retaining portion 32, the retaining portion 32 can be easily inserted into the back side of the assembly space 23, and the water stop member 3 can be smoothly mounted in the assembly space 23 of the housing 2.

The connector according to the present invention is not limited to the above-described embodiment, and various modifications can be made within the scope described in the claims. In addition, the connector 1 according to the present embodiment may be configured by appropriately combining the constituent elements of each embodiment described above and the modifications.

For example, although a case where the connector 1 according to the embodiment described above is mounted on a vehicle has been described, the connector 1 may be used without being mounted on a vehicle.

With the connector of the present embodiment, the water stop member can be smoothly assembled.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A connector comprising:
a housing into which a mating connector is fitted; and
a water stop member mounted in the housing and configured to stop water between the mating connector and the housing, wherein
the housing has a tubular assembly space in which a facing surface of the housing that faces the mating connector is recessed in a fitting direction, and includes a locking protrusion protruding from an outer peripheral wall portion of the assembly space,
the water stop member includes a retaining portion that is arranged in the assembly space and protrudes toward an outer peripheral side from an annular main body portion, and
the main body portion of the water stop member has a cavity portion formed on a distal end side of a proximal end portion of the retaining portion.

2. The connector according to claim 1, wherein
the retaining portion has a curved surface formed at a corner portion that comes into contact with the locking protrusion in a state where the water stop member is mounted in the assembly space.

3. The connector according to claim 1, wherein
the housing has a protruding portion that protrudes from an inner peripheral wall portion of the assembly space toward an outer peripheral side and comes into contact with the retaining portion, and
the protruding portion has a tapered surface obtained by chamfering a corner portion on an inlet side.

4. The connector according to claim 2, wherein
the housing has a protruding portion that protrudes from an inner peripheral wall portion of the assembly space toward an outer peripheral side and comes into contact with the retaining portion, and
the protruding portion has a tapered surface obtained by chamfering a corner portion on an inlet side.

5. The connector according to claim 3, wherein
the retaining portion has a tapered portion formed at a corner portion that comes into contact with the tapered surface in a state where the water stop member is mounted in the assembly space.

6. The connector according to claim 4, wherein
the retaining portion has a tapered portion formed at a corner portion that comes into contact with the tapered surface in a state where the water stop member is mounted in the assembly space.
